(19) United States
(12) Patent Application Publication
(10) Pub. No.: US 2009/0128393 A1
(43) Pub. Date: May 21, 2009

(54) Vehicle integrated antenna

(75) Inventor: Anders Stjernman, Lindome (SE)

Correspondence Address: VENABLE LLP, P.O. BOX 34385, WASHINGTON, DC, 20043-9998, US

(73) Assignee: SAAB AB, Linkoping (SE)

(21) Appl. No.: 12/081,763

(22) Filed: Apr. 21, 2008

(30) Foreign Application Priority Data
Apr. 20, 2007 (EP) 07446005.6

(51) Int. Cl. H01Q 17/00; H01Q 1/32; H01P 11/00

(52) U.S. Cl. 342/4; 343/713; 29/600

(57) ABSTRACT

A method for manufacturing an antenna or antenna array and the antenna or antenna array itself with an operating frequency band, including antenna elements. The antenna or antenna array is integrated in a vehicle structure wherein a radar absorbing material structure, conforming to the shape of the vehicle structure and including at least one layer of radar absorbing material with an inner surface facing the antenna element and an outer surface being an outer surface of the vehicle structure, is mounted in front of the antenna elements. Each radar absorbing material-layer is defined by a thickness and frequency dependent radar absorbing material properties: relative permittivity relative permeability. The frequency dependency of the radar absorbing material properties are tailored and the thickness and the number of radar absorbing material layers is selected such that the radar absorbing material structure is substantially transparent in the operating band, reaching a predetermined Farfield pattern requirement, and simultaneously is an effective absorber, reaching a predetermined Radar Cross Section requirement, at frequencies in a threat band comprising frequencies above the operating frequency band of the antenna, and a radar cross section requirement in the operating frequency band.

### CROSS-REFERENCE TO RELATED APPLICATIONS

This application claims priority to European patent application 07446005.6 filed 20 Apr. 2007.

### TECHNICAL FIELD

The present invention relates to the field of low signature antennas integrated in a vehicle structure.

### BACKGROUND ART

There is a need today for creating a low radar signature for different objects such as e.g. aircrafts, i.e. to design aircrafts having a low radar visibility. Significant progress has been achieved in a number of problem areas as e.g.:
Intake/exhaust
Cockpit/canopy
Hull or fuselage shape
Absorbers
Armament
   but there is often a problem with reducing the passive signature of the aircraft sensors such as antennas.

A number of solutions have been proposed for antennas with a low radar signature or a low Radar Cross Section, RCS.

There are two main problems with existing solutions for creating low RCS with low frequency antenna arrays integrated in a vehicle structure such as a wing edge. Henceforth a vehicle structure is exemplified by a wing edge. Firstly the elements in the antenna array need to be fairly large in order to be resonant, leading to large separations between antenna elements in the array and many grating lobes at higher frequencies. Grating lobes appear in antenna arrays with a periodic repetition of antenna elements and when the distance between elements in the array is greater than a half wavelength. At a frequency of 1 GHz (Giga Hertz) this critical distance is 15 cm.

Secondly the RCS of a straight cylindrical surface is proportional to the local radius of curvature of the surface and to the square of the length divided by the wavelength. Hence the RCS of a wing edge typically increases with frequency. For aero-dynamical reasons the radius of curvature needs to be fairly large with a high RCS as a result, especially at higher frequencies.

In order to reduce the RCS of metallic structures, e.g. including antenna elements, they are coated with Radar Absorbing Materials (RAM). Radar Absorbing Materials are characterized by complex permittivity and permeability values that usually vary with frequency. For planar stratified media with several layers with different properties there is a reflection for each transition and an attenuation of the wave inside the media. Using nonmagnetic purely dielectric media, both the reflections and the attenuation is increased with increasing imaginary part of the dielectric constant, hence there is a trade-off between high attenuation, ensuring low reflection from the inner metallic interface and low reflection from the outer interface. If the reduction in RCS is desired in a narrow frequency band, the thickness of a RAM-layer can be chosen in such way, that the attenuated reflection from the metallic surface has the same magnitude but opposite phase compared to the primary reflection, thereby cancelling it out. For wider frequency bands, this is not possible to accomplish but both the primary reflection and the secondary attenuated reflection need to be low. By using several layers with small change in dielectric properties, the reflection from each interface can be maintained low, while the attenuation is gradually increased, thereby reducing the total required thickness compared with the case when using a single layer with low permittivity material. Another way to accomplish low reflection in the first interface is to use a material with magnetic properties as well. However, the frequency behaviour of the permeability must match the frequency behaviour of the permittivity, and the reflections will only be low at incidence angles close to normal if the permittivity and permeability values are high.

Commercial RAM materials are generally designed to give a good RCS reduction performance in a wide frequency band and have a slow transition from low attenuation and high reflection at low frequencies to high attenuation and low reflection at high frequencies. When using this kind of material in the intended application, either the antenna losses will be unacceptably high or the RCS at medium range frequency will be too high.

Investigations have shown that it is possible to reduce the RCS levels over a frequency band in a threat sector in elevation by optimization of the material parameters and preferably also the shape of the inner profile of a RAM coated wing edge. FIG. 1 shows an antenna array 101 integrated in a wing 102 of an aircraft 103. The treat sector 104 defines an area within which threats like an enemy's radar can be present. The shape of the inner edge is variable and smooth and described by a small number of parameters, e.g. control points of NURBS (Non-Uniform Rational B-Spline), that should be optimized. The RCS value is dependent on the frequency, incident angle and has to be evaluated with computationally demanding CEM (Computational Electro Magnetic) software for each incident angle and frequency value. The RCS and the change of RCS can both be calculated from the electromagnetic field obtained by a CEM (Computational Electro Magnetic) simulation software.

Hence there is a need to provide a method for manufacturing an antenna or antenna array and an antenna or antenna array with a low RCS value integrated in a structure having a large radius of curvature and at the same time accomplish a low attenuation of electromagnetic energy at low frequencies and a low reflection for incident waves at higher frequencies.

### SUMMARY OF THE INVENTION

It is therefore the object of the invention to provide a method for manufacturing an antenna or antenna array, with an operating frequency band, comprising antenna elements integrated in a vehicle structure as well as an antenna or antenna array manufactured according to the method to solve the problem to achieve an antenna or antenna array with low RCS while at the same time accomplishing a low attenuation of electromagnetic energy at low frequencies and a low reflection for incident waves at higher frequencies.

This object is achieved by a method wherein a RAM structure, conforming to the shape of the vehicle structure and comprising at least one layer of RAM material with an inner surface facing the antenna element and an outer surface being an outer surface of the vehicle structure, is mounted in front of the antenna elements, each RAM-layer denoted i being defined by a thickness dᵢ and frequency dependent RAM properties:

relative permittivity ∈ᵢ,
relative permeability μᵢ,
the frequency dependency of the RAM properties being tailored and the thickness dᵢ and the number of RAM layers being selected such that the RAM structure is substantially transparent in the operating band, reaching a predetermined Farfield pattern requirement, and simultaneously is an effective absorber, reaching a predetermined Radar Cross Section (RCS) requirement RCSₜₕ, at frequencies in a threat band comprising frequencies above the operating frequency band of the antenna, and an RCS requirement RCSₒₚ in the operating frequency band. The object is also achieved by an antenna or antenna array manufactured according to the method.

Normally the antenna or antenna array has a continuous operating frequency band, but the frequency band can also, within the scope of the invention, be divided in a number of bands, e.g. separate transmit and receive bands.

In prior art only a single RAM-layer with constant permittivity and permeability and also only incidence in the plane transverse to the wing axis has been considered. Although the wave is scattered in a cone away from the transmitter from an infinite long cylindrical structure for other incidence angles, the finite extent of the wing will introduce side-lobes pointing in the direction of incidence. These side-lobes will be proportional to the specular reflection in the elevation plane, why this reflection has to be considered as well. This is illustrated in FIG. 2. FIG. 2a shows the incident wave 201 with incident angle φᵢ, and reflected or specular wave 202 with angle φₛ. The RCS value 203 caused by the side lobes is plotted in FIG. 2b as a function of angle φ. A high RCS value at φₛ gives an RCS value at φᵢ being proportional to the RCS at φₛ. By reducing the RCS at φₛ the RCS at the incident angle i.e. within the threat sector can be reduced. This suggests the use of low dielectric multilayer RAM instead, which means that each interface between the separate layers has to be parameterized as well as the frequency behaviour of the permeability.

An advantage with the invention is that by tailoring the permittivity ∈ in the RAM layers it will be possible to obtain a faster transition from low attenuation and high reflection at low frequencies to high attenuation and low reflection at high frequencies. This is illustrated in the diagram of FIG. 3. The horizontal axis shows the frequency and the vertical axis the reflection coefficient γ. The antenna or array antenna has an operating bandwidth between frequencies f1 and f2 and at frequency f3, grating lobes are penetrating the threat sector. Those grating lobes are potentially dangerous and have to be reduced. Frequency f3 is the first grating lobe frequency which appears around the double f2 frequency. Curve 301 shows the slow transition of a commercially available RAM material and curve 302 the fast transition of the e-tailored material of the invention. Both materials are PEC (Perfect Electric Conductor) backed, which means that they e.g. are mounted on a metal sheet. The rapid decrease in reflection coefficient in the region between f2 and f3 for curve 302 guarantees that the antenna will function properly at frequencies between f1 and f2, since incident waves here can penetrate the RAM material and is reflected by the PEC, while at the same time the RCS is kept low at frequency f3, since incident waves here are absorbed by the RAM material and the reflections thus becomes low.

FIG. 4 shows one embodiment of the invention where an antenna array is integrated in a wing edge 401 of an aircraft. The antenna elements are here realized as slots 404 located in two rows 405 and 406 in a wing structure 402. A RAM structure 403, having an inner surface 407 and an outer surface 408, is mounted to the wing structure and covering the slots. In this embodiment the RAM structure comprises only one layer of RAM material. The RAM structure can however also comprise several layers as will be shown in the detailed description, in order to reduce the RCS value further.

The invention can advantageously be implemented on wing edges and an outer protective layer can be applied to the RAM structure to increase the mechanical strength of the RAM structure.

The invention can be applied on several types of antenna elements (dipoles, crossed dipoles, patches, fragmented patches etc). It is also possible to apply the invention using different feeds (slots, probes, balanced, unbalanced, etc).

### BRIEF DESCRIPTION OF THE DRAWINGS

FIG. 1 illustrates the threat sector

FIG. 2a schematically shows incident and specular waves

FIG. 2b schematically shows RCS from side lobes of incident waves

FIG. 3 schematically shows the reflection coefficient γ for RAM-materials as a function of frequency.

FIG. 4 schematically shows a perspective view of a wing edge with the invention implemented.

FIG. 5 schematically shows a cross section of a wing edge with the invention implemented.

FIG. 6 shows a diagram of dielectric properties for a tailored RAM structure with four layers

FIG. 7 shows a diagram of reflection coefficient of tailored 4-layer RAM structure.

FIG. 8 shows a diagram of transmission coefficient of tailored 4-layer RAM structure.

FIG. 9 shows a diagram of dielectric properties for a commercially available RAM structure with four layers.

FIG. 10 shows a diagram of reflection coefficient of a commercially available 4-layer RAM structure.

FIG. 11 shows a diagram of transmission coefficient of a commercially available 4-layer RAM structure.

FIG. 12 shows a flowchart of the method

### DETAILED DESCRIPTION

The invention will in the following be described in detail with reference to the drawings.

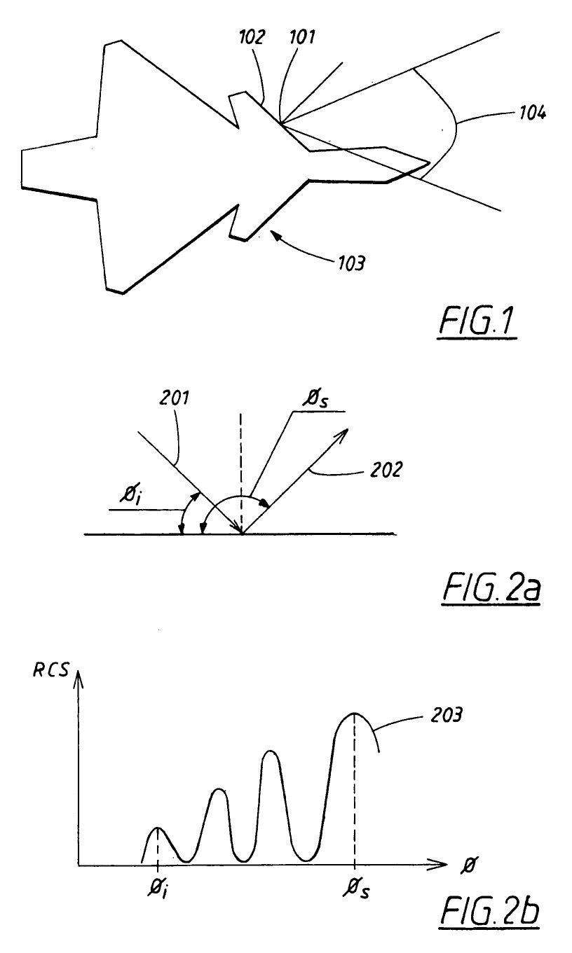

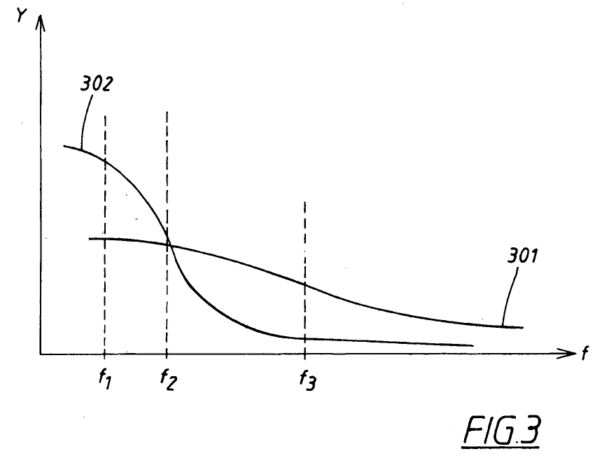

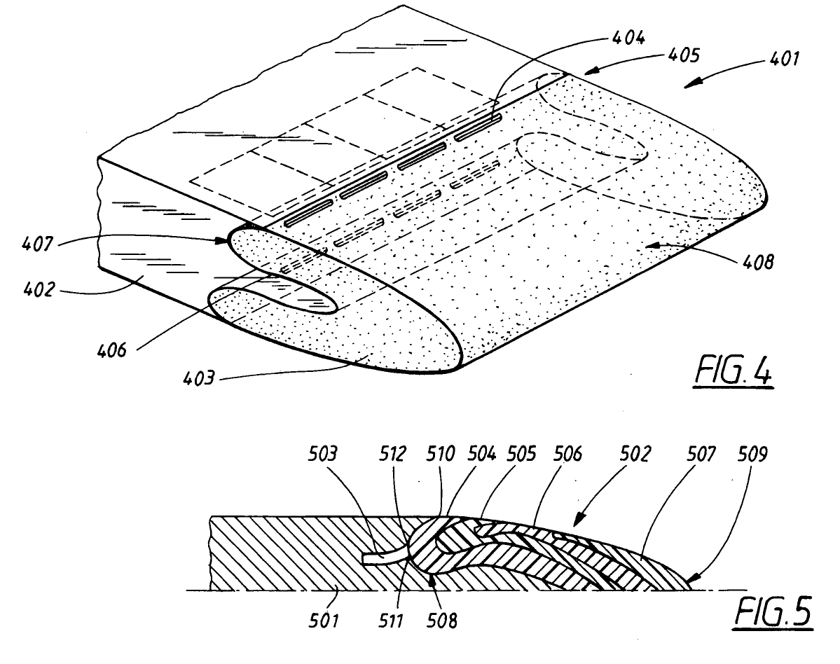

FIG. 1-4 have already been described in connection with Background art and the Summary.

A cross section of an upper half of a wing structure 501 with a RAM structure 502, having an inner surface 508 and outer surface 509, is shown in FIG. 5. The RAM structure 502 comprises RAM layers 504, 505, 506 and 507. An antenna element 503, in this embodiment being a slot, is mounted to the inner surface of the RAM layer 504 with tangential points 511 and 512 to the antenna element surface. A point 510 is defined as an intersection between the inner surface of the RAM structure and the outer profile of the wing structure. Each interface between the different layers is parameterised with a few parameters as well as the dielectric properties of each layer. The position of the antenna element is also parameterised and optimized by replacing the aperture with a line source and calculating the far-field pattern in the elevation plane. When the optimal design is achieved the antenna element is properly designed and matched.

Each layer i in a multilayered RAM is described by their material properties; relative permittivity ∈ᵢ, relative permeability μᵢ and layer thickness dᵢ. The tangential component of the propagation vector for a plane wave travelling with angle θ from the normal in vacuum is k₀ sin θ in all layers, where

$${k}_{0} = \frac{ω}{{c}_{0}}$$

is the wave number in vacuum.

For each interface, the tangential components of both the E-field and H-field are continuous; leading to that the incident wave is split into a transmitted wave and a reflected wave, travelling the opposite normal direction as the incident wave.

The normal component of the propagation vector in layer i is k₀\sqrt{∈ᵢμᵢ−sin² θ}, since the tangential component is the same in each layer. The H-field is perpendicular to the E-field and the direction of propagation, and the E-field is perpendicular to the direction of propagation. The amplitude of the E-field is

$${η}_{0} \sqrt{\frac{{ɛ}_{i}}{{μ}_{i}}}$$

times, η₀=the characteristic impedance in free space, the amplitude of the H-field, hence the tangential component of the E-field is

$${η}_{0} \sqrt{\frac{{ɛ}_{i}}{{μ}_{i}}} \frac{\sqrt{{ɛ}_{i} {μ}_{i} - {sin}^{2} θ}}{\sqrt{{ɛ}_{i} {μ}_{i}}} = {η}_{0} \frac{\sqrt{{ɛ}_{i} {μ}_{i} - {sin}^{2} θ}}{{μ}_{i}}$$

times the tangential component of the H-field, when the E-field is in the plane of incidence.

When the E-field is perpendicular to the plane of incidence, the tangential component of the E-field is

$${η}_{0} \sqrt{\frac{{ɛ}_{i}}{{μ}_{i}}} \frac{\sqrt{{ɛ}_{i} {μ}_{i}}}{\sqrt{{ɛ}_{i} {μ}_{i} - {sin}^{2} θ}} = {η}_{0} \frac{{ɛ}_{i}}{\sqrt{{ɛ}_{i} {μ}_{i} - {sin}^{2} θ}}$$

times the tangential component of the H-field. For other polarisations, the incident wave can be decomposed into a component in the plane of incidence (parallel or TM polarization) and a component perpendicular to the plane of incidence (perpendicular or TE polarization), which can be treated separately.

When the incident wave meets the upper interface, one part of the wave energy is transmitted through the interface and the rest is reflected in the so called specular direction. The amplitude of the reflected wave is determined by that the tangential components of both the H-field and E-field are continuous, giving the relation:

$${E}^{ref} = \frac{{Z}_{i + 1} - {Z}_{i}}{{Z}_{i + 1} + {Z}_{i}} {E}^{inc} ,$$

where

$${Z}_{i} = {η}_{0} \frac{{ɛ}_{i}}{\sqrt{{ɛ}_{i} {μ}_{i} - {sin}^{2} θ}}$$

for TE polarization and

$${Z}_{i} = {η}_{0} \frac{\sqrt{{ɛ}_{i} {μ}_{i} - {sin}^{2} θ}}{{μ}_{i}}$$

for TM polarization. The amplitude of the transmitted wave is given by

$${E}^{trans} = \frac{2 {Z}_{i + 1}}{{Z}_{i + 1} + {Z}_{i}} {E}^{inc} ,$$

and this wave is propagated and attenuated before it reaches the next interface.
E^{ref}=reflected E-field
E^{inc}=incident E-field
E^{trans}=transmitted E-field towards next layer.
Zᵢ=impedance of layer i

For high frequencies the attenuation of the wave is so high, that it does not reach the next interface, the primary reflection is then dominant and should be kept as low as possible. One way of doing this, is to use a material with μᵢ=∈ᵢ, making the reflection coefficient zero at normal incidence. One drawback with this approach is that the reflection coefficient increase rapidly with increasing incidence angles, if the magnitude of μᵢ=∈ᵢ is large. Further, both the permittivity and the permeability are functions of frequency, and it might be difficult to match those over a large frequency band.

A commonly used model for describing the frequency dependency of the relative dielectric constant ∈ᵣ, or permittivity, is the Lorentz model, having 5 parameters according to:

$${ɛ}_{r} = {ɛ}_{∞} + \frac{{ɛ}_{s} - {ɛ}_{∞}}{1 + j \frac{f}{{f}_{rel}} - \frac{{f}^{2}}{{f}_{0}^{2}}} - \frac{{σ}_{e}}{j 2 π f {ɛ}_{0}}$$

where ∈_{∞} is the high frequency limit, ∈ₛ the value at zero frequency, fᵣₑₗ the relaxation frequency, f₀ the resonance frequency, ∈₀ the value in vacuum and finally σₑ the conductivity at zero frequency. Letting the resonance frequency approach infinity reduces the model to the Debye model with 4 parameters:

$${ɛ}_{r} = {ɛ}_{∞} \frac{{ɛ}_{s} - {ɛ}_{∞}}{1 + j \frac{f}{{f}_{rel}}} - \frac{{σ}_{e}}{j 2 π f {ɛ}_{0}} .$$

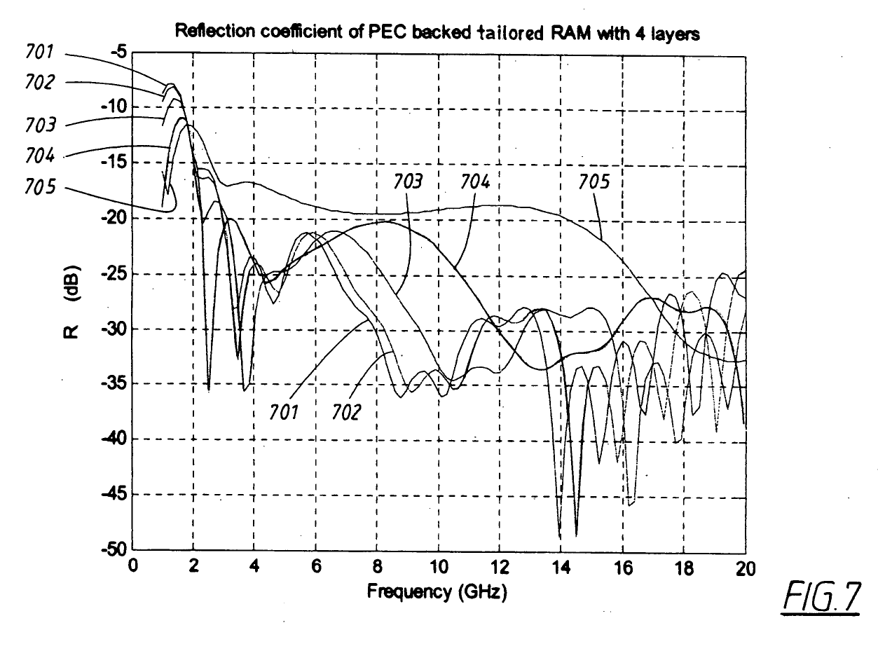

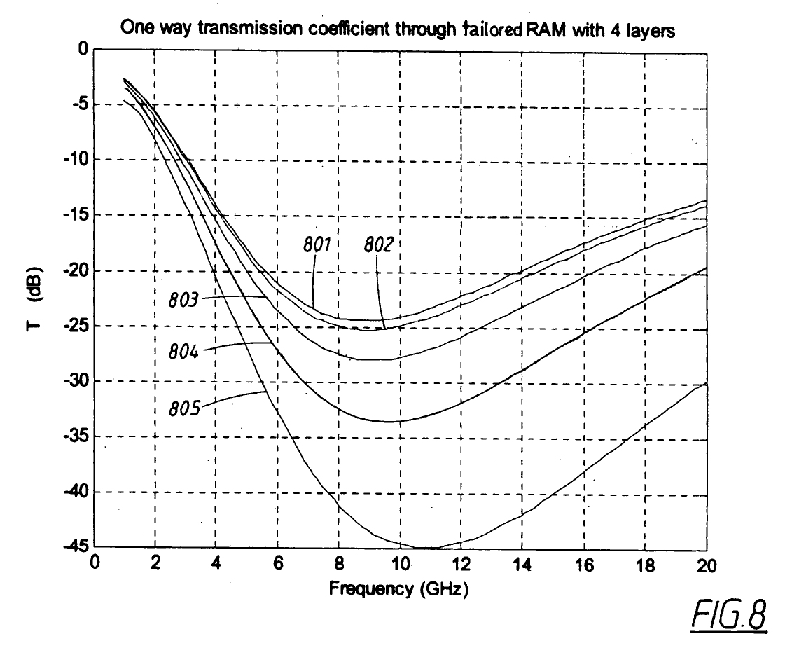

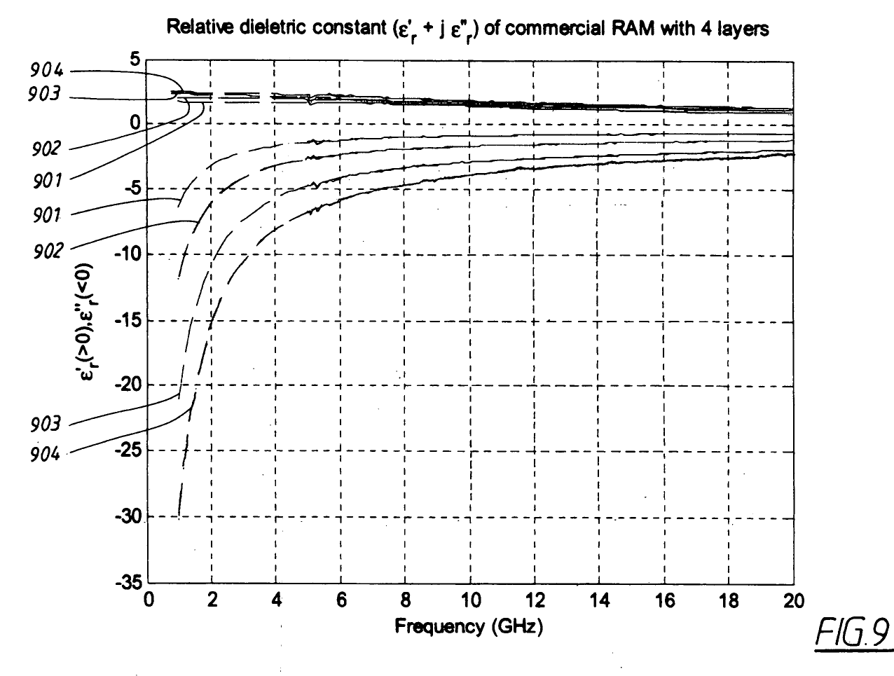

As an example consider a mixture of two materials, one base material with low dielectric constant close to 1 for all frequencies and the other with ∈_{∞}=1, fᵣₑₗ=4 GHz and f₀=8 GHz independently of inclusion material volume fraction and where the other parameters, as ∈ₛ and σₑ, are a function of the volume fraction according to the Maxwell Garnett mixing formula which is the simplest and most widely used model for description of composite media at comparatively low concentrations of inclusions. By proper choice of the volume fraction, values according to FIG. 6 can be achieved for a four layer RAM structure with curve 601, representing the RAM-layer closest to the antenna element, having ∈ₛ=2 and σₑ=0.2, curve 602 having ∈ₛ=1.75 and σₑ=0.15, curve 603 having ∈ₛ=1.5 and σₑ=0.1 and curve 604, representing the RAM-layer being part of the outer surface of the vehicle, having ∈ₛ=1.25 and σₑ=0.05. In this way there will be a gradual increase of the ∈-value from ∈=1 in air to ∈=2 in the layer closest to the antenna element. In FIG. 6 the horizontal axis represents frequency in GHz and the vertical axis the ∈ᵣ-value calculated according to the Lorentz model with ∈_{∞}=1, fᵣₑₗ=4 GHz and f₀=8 GHz. Assuming a planar stratified media with 4 layers with 25 mm thickness each, the reflection coefficient R can be calculated according to FIG. 7, when the RAM structure is placed upon a Perfect Electric Conductor (PEC). The calculated reflection coefficient R, is represented on the vertical axis and frequency in GHz on the horizontal axis. Five different incident angles φ are plotted, curve 701 with φ=0°, curve 702 with φ=15°, curve 703 with φ=30°, curve 704 with φ=45° and curve 705 with φ=60°. The incident angles φ is in FIG. 7 and following figures defined as the angle between the normal to the RAM surface and the incident wave. The calculated transmission through the layers when the PEC is replaced with vacuum is shown in FIG. 8 with transmission coefficient T on the vertical axis and frequency in GHz on the horizontal axis. T and R are calculated both for TE (Transverse Electric) and TM (Transverse Magnetic) polarization according to conventional methods well known to the skilled person. The structure according to FIG. 8 is approximately equal to the maximum available efficiency for an antenna transmitting through the RAM structure. Five different incident angles are plotted, curve 801 with φ=0°, curve 802 with φ=15°, curve 803 with φ=30°, curve 804 with φ=45° and curve 805 with φ=60°. As can be seen in the figures the reflection above 3 GHz is essentially less than −20 dB (see FIG. 7) and the transmission at 1 GHz is better than 3-4 dB (see FIG. 8). Another possibility to achieve similar results is to use inclusion of shaped particles of different sizes and volumetric fractions or to use materials with different Debye and Lorentz parameters.

In practice, materials with such low dielectric constant as in the outer layer in the example above have poor mechanical properties. In this example the arrangement has to be protected with a thin layer of mechanical stability, often having a larger dielectric constant or permittivity. The material properties of this layer have to be taken into account in the optimization of the structure.

As a comparison with what is typically achieved with commercial RAMs, data from a user supplied data sheet is fitted to a Debye model. The data was only available between 5 and 18 GHz and the original data is displayed with solid curves, the fitted data is shown with dashed curves in FIG. 9 for four different ∈ᵣ-values shown in curves 901-904. The vertical axis represents the ∈ᵣ-value and the horizontal axis the frequency in GHz. As seen it is excellent agreement between supplied data and the modelled data as the dashed and solid lines more or less coincides after 5 GHz suggesting that the Debye model is a proper description of the materials used.

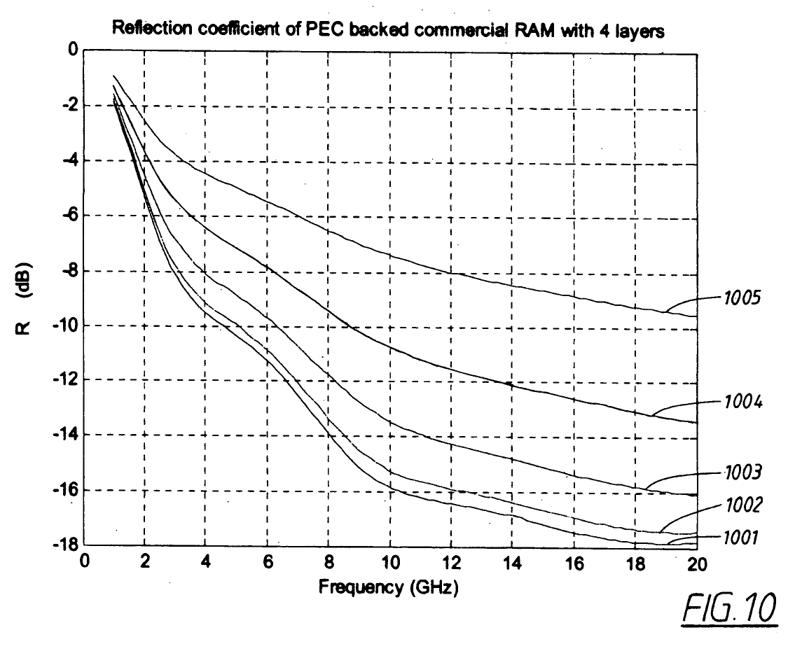

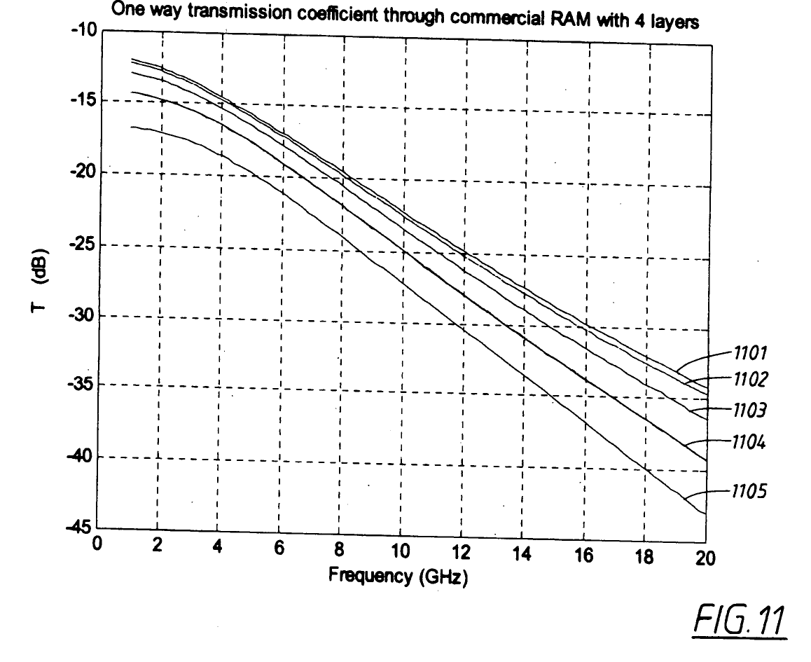

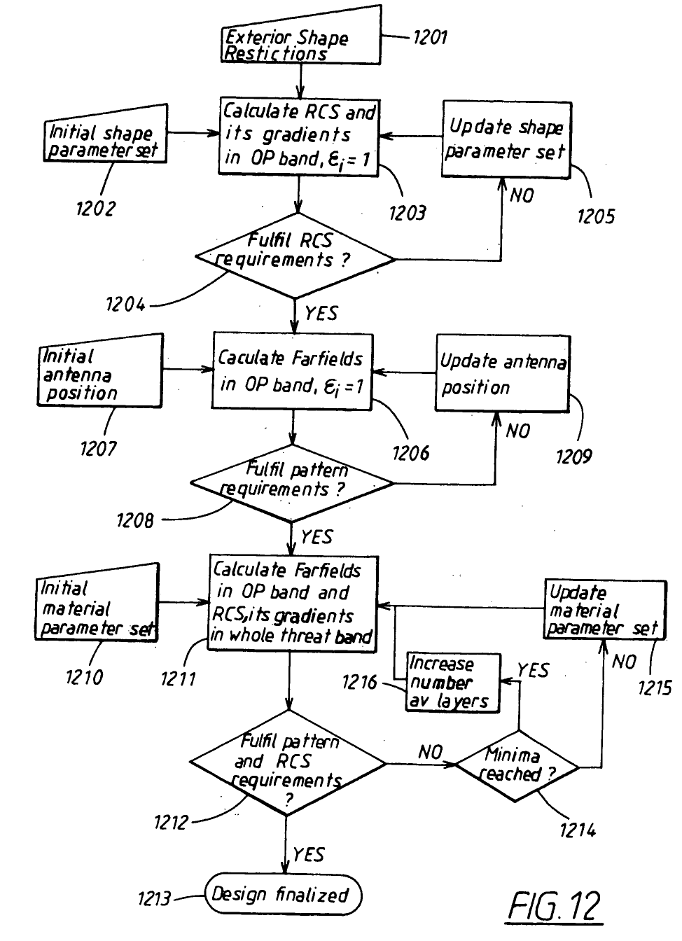

FIG. 10 shows the reflection coefficient R on the vertical axis and the frequency in GHz on the horizontal axis for a commercially available RAM structure with four layers and for five different incident angles φ, curve 1001 with φ=0°, curve 1002 with φ=15°, curve 1003 with φ=30°, curve 1004 with φ=45° and curve 1005 with φ=60°. FIG. 11 shows the corresponding transmission coefficient T on the vertical axis and the frequency in GHz on the horizontal axis for a commercially available RAM structure with four layers and for five different incident angles φ, curve 1101 with φ=0°, curve 1102 with φ=15°, curve 1103 with φ=30°, curve 1104 with φ=45° and curve 1105 with φ=60°.

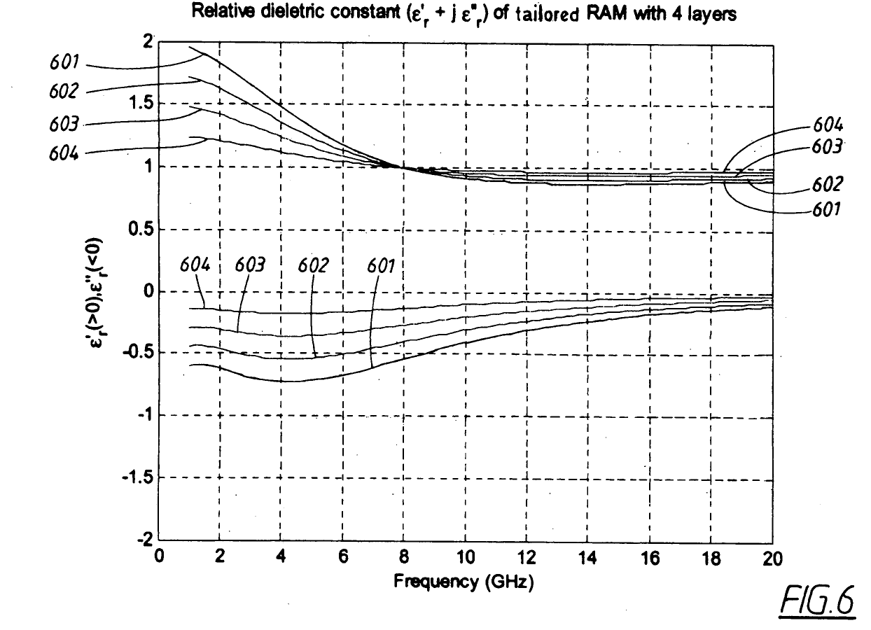

When FIG. 7, having a RAM structure with tailored ∈-values, is compared to the corresponding curves for a commercially available RAM structure in FIG. 10, it can be seen that the reflection coefficient is much lower for the ∈-tailored RAM, typically below 20 dB from 3 GHZ while the commercially available RAM structure has a reflection coefficient around 5-15 dB in the interval 3-10 GHz. This means that the ∈-tailored RAM structure gives much lower reflections for incident waves and hence a better RCS value. When the curves for the transmission coefficients for ∈-tailored RAM, FIG. 8, is compared to the corresponding curves for the commercially available RAM structure of FIG. 11, it can be seen that the transmission coefficient around 1 GHz is around 3-5 dB for ∈-tailored RAM and 12-14 dB for the commercially available RAM structure. Hence the ∈-tailored RAM structure gives an improvement of transmission in the order of 10 dB in the operating band of the antenna array. In summary the result is that the ∈-tailored RAM structure represents curve 302 in FIG. 3 and the commercially available RAM structure curve 301 in the same figure.

The curve shape of the RAM-layers can be calculated using the Continuum Sensitivity Based approach for optimization. This is done by solving the E-field for TM polarization or the H-field for TE polarization for a set of frequencies, incidence angles and parameter values. The character σ is conventionally used for denoting RCS. Henceforth σ is therefore used for RCS and should not be mixed up with σₑ used for conductivity. The change ∂σ of the radar cross section by a small displacement ∂ξᵢ in the normal direction of an interface between two different media i and i+1 can be expressed as an integral over the interface of an expression involving the solution to the problem and the solution of the adjoint problem (as described by Yongtao Yang in “Continuum Sensitivity Based Shape and Material Optimization for Microwave Applications”, Ch almers University of Technology, 2006, ISBN 91-7291-73-7):

$$\partial σ = \frac{2}{{k}_{0} {\vert {E}_{0} \vert}^{2}} Re \{ \int \partial {ξ}_{i} [ ( \frac{1}{{μ}_{i + 1}} - \frac{1}{{μ}_{i}} ) ∇ {E}_{a} \cdot ∇ E - {k}_{0}^{2} ( {ɛ}_{i + 1} - {ɛ}_{i} ) {E}_{a} E ] d l \}$$

for TM polarisation and

$$\partial σ = \frac{- 2}{{k}_{0} {\vert {H}_{0} \vert}^{2}} Re \{ {\int }_{Γ} \partial {ξ}_{i} [ ( \frac{1}{{ɛ}_{i + 1}} - \frac{1}{{ɛ}_{i}} ) ∇ {H}_{a} \cdot ∇ H - {k}_{0}^{2} ( {μ}_{i + 1} - {μ}_{i} ) {H}_{a} H ] d l \}$$

for TE polarisation. Similarly, the change of RCS by a small change ∂∈ᵢ and ∂μᵢ in material parameters is given by the surface integrals

$$\partial σ = \frac{2}{{k}_{0} {\vert {E}_{0} \vert}^{2}} Re \{ {\int }_{{S}_{i}} [ - \frac{\partial {μ}_{i}}{{μ}_{i}^{2}} ∇ {E}_{a} \cdot ∇ E - {k}_{0}^{2} \partial {ɛ}_{i} {E}_{a} E ] d S \} and$$

$$\partial σ = \frac{- 2}{{k}_{0} {\vert {H}_{0} \vert}^{2}} Re \{ {\int }_{{S}_{i}} [ - \frac{\partial {ɛ}_{i}}{{ɛ}_{i}^{2}} ∇ {H}_{a} \cdot ∇ H - {k}_{0}^{2} \partial {μ}_{i} {H}_{a} H ] d S \}$$

The RCS value is calculated according to:

$$σ = 4 π R \frac{{\vert {E}_{s} \vert}^{2}}{{\vert {E}_{0} \vert}^{2}}$$

∈ᵢ=relative permittivity
μᵢ=relative permeability
k₀=wave number in vacuum
∫_{Γ}=line integral at interface between media i+1 and i
∫_{S}_{ᵢ}=surface integral over the area defined by layer i
|E₀|²=the square of the incident E-field amplitude
|H₀|²=the square of the incident H-field amplitude
∇E=the gradient of the E-field
∇Eₐ=the gradient of the adjoint E-field as defined by Yongtao Yang in “Continuum Sensitivity Based Shape and Material Optimization for Microwave Applications”
∇H=the gradient of the H-field
∇Hₐ=the gradient of the adjoint H-field as defined by Yongtao Yang in “Continuum Sensitivity Based Shape and Material Optimization for Microwave Applications”
|Es|²=the square of the scattered E-field amplitude at distance R
R=distance from scattering source

The formulas for the RCS value and gradients above are valid for calculations in 2D but when necessary, calculations can also be performed in 3D using corresponding 3D formulas.

Also the H-field at any point on the inner PEC interface can be determined for each set of values. By reciprocity, the far field radiation pattern of a magnetic current line source placed in the corresponding point can be determined. The radiation efficiency can be determined by integrating the Farfield radiation pattern and the power delivered into the media surrounding the line source. The Farfield radiation pattern is defined as the vector product between the E- and H-field. All calculations of the Farfield in this description are made for both TE and TM polarization. In a corresponding way the E-field at any point on the inner PEC interface can be determined and by reciprocity the far field radiation pattern of an electric current line source placed in the corresponding point can be determined.

A suitable cost-function involving RCS, desired radiation pattern and efficiency has to be minimized, the partial derivatives of the cost function with respect to the design parameters can be determined by the chain rule, leading to fast convergence of gradient search algorithms.

Investigating the responses shown in FIG. 10 and FIG. 11 it is clearly seen that the high level of reflection at 1 GHz in FIG. 10 is dominated by reflections in the interfaces between the different layers leading to the rather low transmission coefficient for the vacuum backed arrangement as shown in FIG. 11. These reflections can to a certain extent be compensated for by replacing the vacuum with a matched layer of complex impedance leading to a higher power transfer to the matched layer as compared with the vacuum case. Perfect match can only be obtained for a single frequency but since the material is lossy, the bandwidth can be rather large. This matching principle can also be used for a RAM structure according to the invention.

The method for the invention shall now be described with reference to the flow chart in FIG. 12. The first step is to decide an initial shape of the inner surface 407 of the RAM structure. Exterior shape restrictions 1201 have to be considered after which an initial shape is defined in 1202 by a curve calculated using a number of control points giving a smooth curve through these points. Different conventional mathematical algorithms can be used to obtain the curve e.g. by Continuum sensitivity based approach as described above. Necessary control points are e.g. intersection points 510 with the outer profile of the wing structure.

In 1203 an RCSₒₚ value (RCS in operating band) for cross-polarized waves with a frequency in the operating band is calculated for the selected initial shape assuming one RAM layer with ∈ᵢ=1, i.e. for air, according to formula:

$$σ = 4 π R \frac{{\vert {E}_{s} \vert}^{2}}{{\vert {E}_{0} \vert}^{2}}$$

RCSₒₚ gradients are also calculated according to:

$$\partial σ = \frac{2}{{k}_{0} {\vert {E}_{0} \vert}^{2}} Re \{ {\int }_{Γ} \partial {ξ}_{i} [ ( \frac{1}{{μ}_{i + 1}} - \frac{1}{{μ}_{i}} ) ∇ {E}_{a} \cdot ∇ E - {k}_{0}^{2} ( {ɛ}_{i + 1} - {ɛ}_{i} ) {E}_{a} E ] d l \}$$

for TM polarization and

$$\partial σ = \frac{- 2}{{k}_{0} {\vert {H}_{0} \vert}^{2}} Re \{ {\int }_{Γ} \partial {ξ}_{i} [ ( \frac{1}{{ɛ}_{i + 1}} - \frac{1}{{ɛ}_{i}} ) ∇ {H}_{a} \cdot ∇ H - {k}_{0}^{2} ( {μ}_{i + 1} - {μ}_{i} ) {H}_{a} H ] d l \}$$

for TE polarization
in order to decide whether a minimum RCSₒₚ value has been obtained for the selected parameter set. The calculations are made both for TE (Transverse Electric) and TM (Transverse Magnetic) polarizations.

In 1204 the calculated RCSₒₚ value is compared to the predetermined RCSₒₚ requirement for the operating band with one RAM-layer and ∈ᵢ=1.

If the requirement is not met the initial shape is updated with a new parameter set in 1205 and new calculations are made according to 1203. The resulted RCS value is again compared with predetermined requirements and if the requirement is met the procedure continuous to 1206, otherwise a new loop is made through 1205 and 1203 until the requirement is met.

In 1206 the Farfield in the operating band is calculated with ∈ᵢ=1 and with an initial position 1207 of the antenna elements along the initial shape with the tangential points 511 and 512 of the inner surface 508 mounted to the antenna element surface. The Farfield is calculated using a CEM (Computational Electro Magnetic) simulation with a magnetic or electric current line source at the position of the antenna element.

The calculations are made both for TE (Transverse Electric) and TM (Transverse Magnetic) polarizations. In 1208 a comparison is made with predetermined values for the Farfield. If requirements are not met positions of the antenna elements are updated in 1209 and new calculations are made according to 1206. A new comparison with predetermined requirements is made in 1208 and if the requirement is met the procedure continuous to 1211, otherwise a new loop is made through 1209 and 1206 until the requirement is met.

In 1210 a one layer RAM is selected with an er-value calculated according to the Debye model:

$${ɛ}_{r} = {ɛ}_{∞} + \frac{{ɛ}_{s} - {ɛ}_{∞}}{1 + j \frac{f}{{f}_{rel}}} - \frac{{σ}_{e}}{j 2 π f {ɛ}_{0}}$$

where ∈ᵣ=relative permittivity for the RAM-layer, ∈ₛ=relative permittivity for the RAM-layer at zero frequency, ∈_{∞}=relative permittivity for the RAM-layer at high frequency limit, ∈₀=relative permittivity for the RAM-layer at a resonance frequency of the RAM-material, f=operating frequency of the antenna, fᵣₑₗ=relaxation frequency, σₑ=conductivity at zero frequency. Examples of how to achieve different ∈ᵣ-values have been described above.

In 1211 following calculations are now made with the selected shape of the inner surface, antenna element positions and ∈ᵣ-value:
Farfield for TE and TM polarizations in operating frequency band as described in 1206 above
RCSₜₕ-values (RCS in threat band) and gradients of RCSₜₕ are calculated in the whole threat band according to the same principles as described for 1203 above.

A comparison is made in 1212 against predetermined requirements for the Farfield in operating band and the RCSₜₕ values in the threat band for both TE and TM polarizations. If the requirements are met the design is finalized in 1213 and if not, a check is made in 1214 to see if a minimum is reached for a cost function including the Farfield pattern and the RCSₜₕ value. A cost function is an optimization algorithm which reaches a minimum when the parameters are optimized according to the conditions in the algorithm as further described above. If a cost function minimum is not reached the material parameter set made in 1210 is updated in 1215 and new calculations are made in 1211. A new comparison is made in 1212, if OK the design is finalized, otherwise a new check in 1214 is made. The loop continues until the procedure ends up in 1213 or when it is established in 1214 that the cost function minima is obtained. The procedure then continues to 1216 where the number of RAM-layers is increased by one and additional material parameters as e.g. interface shape parameters and thicknesses of RAM-layers are introduced. New calculations are then made in 1211 and the loop continues until the requirements are met in 1212 and the design is finalized.

Normally the calculation are made for the relative permeability μᵢ=1. However the scope of the invention is not limited to a fixed μᵢ-value, but this value can also be used as a variable parameter in the design process.

The invention is not limited to the embodiments above, but may vary freely within the scope of the appended claims.

1. A method for manufacturing an antenna or antenna array, with an operating frequency band, comprising antenna elements integrated in a vehicle structure, radar absorbing material structure, conforming to a shape of the vehicle structure and comprising at least one layer of radar absorbing material with an inner surface facing an antenna element and an outer surface being an outer surface of the vehicle structure, is mounted in front of the antenna elements, each radar absorbing material-layer i being defined by a thickness dᵢ and frequency dependent radar absorbing material properties:
relative permittivity ∈ᵢ
relative permeability μ_{i,}
the method comprising:
tailoring the frequency dependency of the radar absorbing material properties being and selecting a thickness dᵢ and a number of radar absorbing material layers such that the radar absorbing material structure is substantially transparent in an operating frequency band, reaching a predetermined Farfield pattern requirement, and simultaneously is an effective absorber, reaching a predetermined Radar Cross Section requirement RCSₜₕ, at frequencies in a threat band comprising frequencies above the operating frequency band of the antenna, and an radar cross section requirement RCSₒₚ in the operating frequency band.

2. The method according to claim 1, further comprising:
selecting an initial shape of the inner surface of a one layer radar absorbing material structure with a relative permittivity ∈ᵢ=1 so as to reach the predetermined RCSₒₚ requirement for cross-polarized waves in the operating frequency band.

3. The method according to claim 2, wherein determining the RCSₒₚ value comprises:
defining an initial shape by a curve calculated according to mathematical algorithms using a parameter set comprising a number of control points through which the curve shall pass and giving a smooth curve through these points,
calculating an RCSₒₚ value and gradients of RCSₒₚ for the curve according to:
$$σ = 4 π R \frac{{\vert {E}_{s} \vert}^{2}}{{\vert {E}_{0} \vert}^{2}}$$
for TE and TM polarization
and
$$\partial σ = \frac{2}{{k}_{0} {\vert {E}_{0} \vert}^{2}} Re \{ {\int }_{Γ} \partial {ξ}_{i} [ ( \frac{1}{{μ}_{i + 1}} - \frac{1}{{μ}_{i}} ) ∇ {E}_{a} \cdot ∇ E - {k}_{0}^{2} ( {ɛ}_{i + 1} - {ɛ}_{i} ) {E}_{a} E ] d l \}$$
for TM polarisation and
$$\partial σ = \frac{- 2}{{k}_{0} {\vert {H}_{0} \vert}^{2}} Re \{ {\int }_{Γ} \partial {ξ}_{i} [ ( \frac{1}{{ɛ}_{i + 1}} - \frac{1}{{ɛ}_{i}} ) ∇ {H}_{a} \cdot ∇ H - {k}_{0}^{2} ( {μ}_{i + 1} - {μ}_{i} ) {H}_{a} H ] d l \}$$
for TE polarisation and
testing different parameter sets until a curve is obtained which meets the predetermined RCSₒₚ requirement.

4. The method according to claim 2, further comprising:
determining an initial position for the antenna elements for a one layer radar absorbing material structure with a relative permittivity ∈ᵢ=1 so as to reach the predetermined Farfield pattern requirement in the operating frequency band.

5. The method according to claim 4, further comprising:
calculating the Farfield of the antenna or antenna array for a one layer radar absorbing material structure with a relative permittivity ∈ᵢ=1 for different positions until the predetermined Farfield pattern requirement is met.

6. The method according to claim 5, further comprising:
calculating the Farfield pattern in the operating frequency band and calculating RCSₜₕ and gradients of RCSₜₕ in the threat band using at least one radar absorbing material-layer and the different frequency dependent radar absorbing material parameters until the predetermined requirements for the Farfield pattern and the RCSₜₕ are met.

7. The method according to claim 5, wherein the Farfield is calculated according to a computational electro magnetic simulation with a magnetic or electric current line source at the point of the antenna element.

8. The method according to claim 6, wherein RCSₜₕ and gradients of RCSₜₕ are calculated according to:
$$σ = 4 π R \frac{{\vert {E}_{s} \vert}^{2}}{{\vert {E}_{0} \vert}^{2}}$$
for TE and TM polarization
and
$$\partial σ = \frac{2}{{k}_{0} {\vert {E}_{0} \vert}^{2}} Re \{ {\int }_{Γ} \partial {ξ}_{i} [ ( \frac{1}{{μ}_{i + 1}} - \frac{1}{{μ}_{i}} ) ∇ {E}_{a} \cdot ∇ E - {k}_{0}^{2} ( {ɛ}_{i + 1} - {ɛ}_{i} ) {E}_{a} E ] d l \}$$
for TM polarisation and
$$\partial σ = \frac{- 2}{{k}_{0} {\vert {H}_{0} \vert}^{2}} Re \{ {\int }_{Γ} \partial {ξ}_{i} [ ( \frac{1}{{ɛ}_{i + 1}} - \frac{1}{{ɛ}_{i}} ) ∇ {H}_{a} \cdot ∇ H - {k}_{0}^{2} ( {μ}_{i + 1} - {μ}_{i} ) {H}_{a} H ] d l \}$$
for TE polarisation.

9. The method according to claim 6, further comprising:
calculating a value for the relative permittivity for each radar absorbing material-layer from the Debye model:
$${ɛ}_{r} = {ɛ}_{∞} + \frac{{ɛ}_{s} - {ɛ}_{∞}}{1 + j \frac{f}{{f}_{rel}}} - \frac{{σ}_{e}}{j2 π f {ɛ}_{0}}$$
where ∈ᵣ=relative permittivity for the radar absorbing material-layer, ∈ₛ=relative permittivity for the RAM-layer at zero frequency, ∈_{∞}=relative permittivity for the radar absorbing material-layer at high frequency limit, ∈₀=relative permittivity for the radar absorbing material-layer at a resonance frequency of the radar absorbing material-material, f=operating frequency of the antenna, fᵣₑₗ=relaxation frequency, σₑ=conductivity at zero frequency.

10. The method according to claim 6, wherein the relative permittivity ∈ᵣ is affected by inclusion of shaped particles of different sizes and volumetric fractions or materials with different Debye and Lorentz parameters.

11. The method according to claim 10, wherein the particles comprise bars or nano-tubes of carbon fibre or metal particles.

12. The method according to claim 1, further comprising:
applying an outer protective layer to the radar absorbing material structure.

13. The method according to claim 1, wherein the method is applied to a vehicle structure being a wing edge of an aircraft.

14. An antenna or antenna array with an operating frequency band, comprising:
antenna elements integrated in a vehicle structure, wherein a radar absorbing material structure, conforming to a shape of the vehicle structure and comprising at least one layer of radar absorbing material with an inner surface facing the antenna element and an outer surface being an outer surface of the vehicle structure is mounted in front of the antenna elements, each radar absorbing material-layer i having a thickness dᵢ and frequency dependent radar absorbing material properties:
relative permittivity ∈ᵢ
relative permeability μᵢ,
a frequency dependency of radar absorbing material properties being tailored and a thickness dᵢ and number of radar absorbing material layers having values such that the radar absorbing material is substantially transparent at an operating frequency of the antenna, reaching a predetermined Farfield pattern requirement, and simultaneously is an effective absorber, reaching a predetermined Radar Cross Section requirement RCSₜₕ, at frequencies in a threat band comprising frequencies above the operating frequency band of the antenna, and an RCS requirement RCSₒₚ in the operating frequency band.

15. The antenna or antenna array according to claim 14, wherein the antenna elements comprise slots, dipoles, crossed dipoles, patches or fragmented patches.

16. The antenna or antenna array according to claim 14, wherein an RF-feed of the antenna elements comprises galvanic feeding or feeding through slots or probes in balanced or unbalanced configuration.

17. The antenna or antenna array according to claim 14, further comprising:
an outer protective layer applied to the radar absorbing material structure.

18. The antenna or antenna array according to claim 14, wherein the vehicle structure comprises a wing edge of an aircraft.
